(19) United States
(12) Patent Application Publication
(10) Pub. No.: US 2025/0080251 A1
(43) Pub. Date: Mar. 6, 2025

(54) DEVICES, SYSTEMS AND METHODS FOR REDUCING TRAFFIC IN A LOCATION TRACKING ENVIRONMENT

(71) Applicant: Inovonics Wireless Corporation, Westminster, CO (US)

(72) Inventor: Eric S. Roth, Broomfield, CO (US)

(21) Appl. No.: 18/777,656

(22) Filed: Jul. 19, 2024

Related U.S. Application Data
(60) Provisional application No. 63/579,330, filed on Aug. 29, 2023.

(51) Int. Cl. H04B 17/318; H04B 17/27

(52) U.S. Cl. CPC H04B 17/318; H04B 17/27

(57) ABSTRACT

A device may include a communication interface and processing logic. The processing logic may be configured to receive a signal from a wearable device, determine a signal strength of the received signal and receive, via the communication interface, messages from a plurality of other devices that received the signal. Each message may include a signal strength value corresponding to a signal strength measured by one of the plurality of other devices. The processing logic may further be configured to determine whether the device received the signal with a greatest signal strength, and transmit, via the communication interface and in response to determining that the device received the signal with the greatest signal strength, a message to a monitoring device indicating an identifier (ID) of the wearable device and a location of the device or an ID associated with the device.

### RELATED APPLICATION

This application claims priority under 35 U.S.C. § 119 based on U.S. Provisional Application No. 63/579,330 filed Aug. 29, 2023, titled “Devices, Systems and Methods for Reducing Traffic in a Location Tracking Environment,” the disclosure of which is hereby incorporated herein by reference in their entirety.

### BACKGROUND INFORMATION

A pendant, such as a location tracking pendant or a duress pendant, is typically worn around the neck of a person, around the wrist of the person or clipped to the person's belt. The pendant may be used to track the location of the wearer of the pendant and may include one or more sensors to automatically detect an event (e.g., a fall, a request for help, etc.). In some scenarios, the pendant also transmits a beacon signal at regular intervals to one or more receiving devices placed at fixed locations. The receiving devices are used to determine the approximate location of the person wearing the pendant at any given time.

For example, each receiving device may measure the received signal strength of the pendant's beacon and relay that information to a central monitoring device. The central monitoring device may then identify the receiving device that received the beacon signal having the greatest signal strength and determine that the person wearing the pendant is located closest to that receiving device. This process is repeated at periodic intervals to provide near real-time location information associated with people wearing pendants.

In environments which include a large number of pendants and a large number of receiving devices, data traffic associated with the receiving devices transmitting signal strength information to a central monitoring system may become significant. Further, in scenarios in which a data backhaul network or medium associated with transmitting the received signal strength information is shared with another system, the large amount of traffic associated with attempting to identify locations of pendants can cause a degradation and/or overload of the backhaul network/medium.

### BRIEF DESCRIPTION OF THE DRAWINGS

FIG. 1 illustrates an exemplary environment in which systems and methods described herein may be implemented;

FIG. 2 is a block diagram of components implemented in one or more of the elements of the environment of FIG. 1 in accordance with an exemplary implementation;

FIG. 3 is a block diagram of logic components included in the locators of FIG. 1 in accordance with an exemplary implementation;

FIG. 4 illustrates an exemplary table used to store beacon signal strength information associated with the environment of FIG. 1; and

FIG. 5 is a flow diagram illustrating processing associated with the environment of FIG. 1 in accordance with exemplary implementations.

### DETAILED DESCRIPTION OF EMBODIMENTS

The following detailed description refers to the accompanying drawings. The same reference numbers in different drawings may identify the same or similar elements.

Implementations described herein provide devices, systems and methods for reducing traffic in a network associated with a pendant. In one implementation, a pendant transmits beacon signals at predetermined intervals that are detected by various locator devices in wireless range of the pendant. The locator devices identify a signal strength of the beacon and transmit the received signal strength information to other locator devices. The locator devices then compare their received signal strength value associated with the beacon with the signal strength values measured by the other locator devices. The locator device that received the strongest signal with respect to the beacon may then transmit location and/or other information to a central monitoring system, which tracks the locations of the pendants. In this manner, data traffic associated with transmitting location information is reduced by having only one of the N locator devices transmit location information. This reduces data traffic by a factor of N:1 as compared to each locator transmitting location information to a central monitoring facility, thereby reducing data collisions, as well as reducing traffic congestion and overload on the network medium.

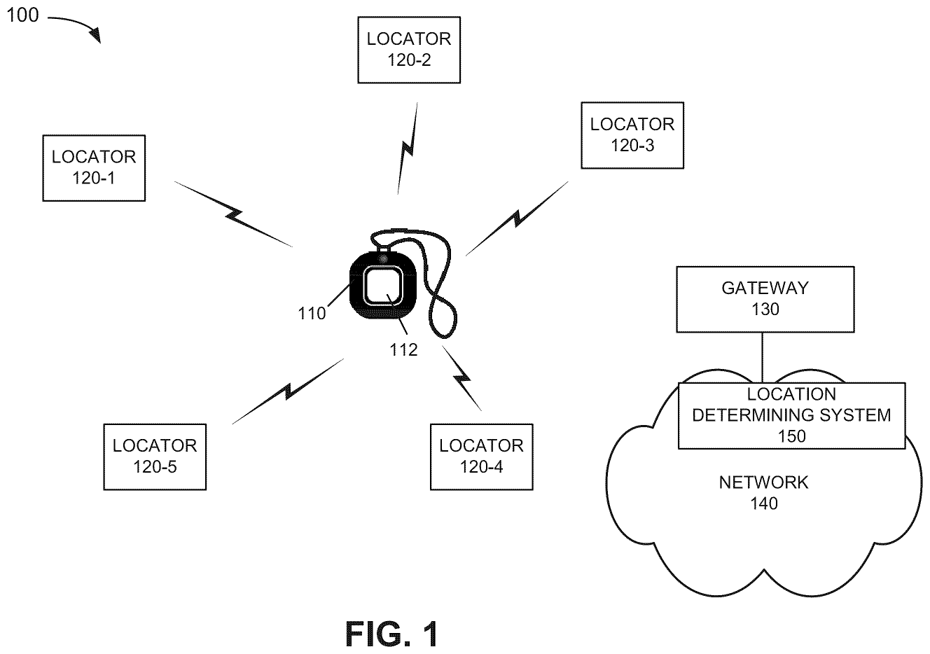

FIG. 1 is a diagram illustrating an exemplary environment 100 in which systems and methods described herein may be implemented. Referring to FIG. 1, environment 100 includes pendant 110, locators 120-1 through 120-5 (also referred to herein as anchors), gateway 130, network 140 and location determining system 150.

Pendant 110 may include a device designed to be worn by a user around the user's neck via a cord, lanyard, necklace or attachment mechanism. In other implementations, pendant 110 may be worn on the wrist of the user or be included in a smart watch worn on the user's wrist. In an exemplary implementation, pendant 110 includes a location tracking pendant used to detect a location of the wearer of pendant 110. In another exemplary implementation, pendant 110 may include a fall detection pendant that includes one or more sensors (e.g., an accelerometer) to measure acceleration of pendant 110 and one or more pressure sensors (e.g., a barometric pressure sensor) configured to detect the barometric pressure in the area in which pendant 110 is located. The accelerometer and pressure sensor may be used to detect whether a wearer of pendant 110 has fallen. Pendant 110 may also include a “call button” 112 located on the face of pendant 110. The call button 112 may be pressed and allow the user to establish communications with or send an alert to a system monitored by personnel, such as location determining system 150 and/or an emergency call system (not shown in FIG. 1). In each case, pendant 110 may interface with locators 120 to allow locators 120 to determine the location of the wearer of pendant 110, as described in detail below.

In an exemplary implementation, pendant 110 may also transmit a beacon signal at predetermined intervals that can be received by any locator 120 located within the wireless transmission range of pendant 110. The wireless signal may be transmitted using, for example, Bluetooth (e.g., Bluetooth Low Energy (BLE)) or another wireless protocol, and the wireless signal may include information particularly identifying pendant 110, such as a unique ID for pendant 110.

Locators 120-1 through 120-5 (referred to individually as locator 120-X, wherein X is any integer, or locator 120, and referred to collectively as locators 120) may each include a device configured to determine a location associated with pendant 110. For example, each locator 120 may be mounted at a fixed location, such as in a particular room or hallway in a senior or assisted living community, hospital, etc., and may be programmed to store its predetermined location information in an internal memory. In other implementations, location determining system 150 may store the physical location information of locators 120 along with an identifier (ID) for each locator 120. For example, location determining system 150 may store information indicating that locator 120 with an ID of 12345678 is located in Room 112.

As described above, pendant 110 may transmit a beacon signal, at predetermined intervals, that can be received by any locator 120 located within the wireless transmission range of pendant 110. Locator 120 may receive the signal from pendant 110 and/or other pendants 110 within the wireless range of locator 120 and measure the strength of the received beacon signal. Locator 120 may also receive signals from other locators 120 that include signal strength information associated with the beacon signal received by the other locators 120, as described in detail below. Each locator 120 may then determine whether that locator 120 is located closest to pendant 110 and if so, transmit location information to, for example, location determining system 150, as described in detail below. For example, the signal strength of the received signal is inversely proportional to the distance from the pendant 110 (e.g., inversely proportional to the square of the distance). Therefore, locator 120 receiving the beacon having the greatest signal strength will be assumed to be the locator 120 located closest to pendant 110 In some implementations, locator 120 may forward the location information to network 140 via a repeater and/or network coordinator device (not shown) using wired or wireless mechanisms. In each case, a locator 120-X may forward location information regarding pendant 110 when that locator 120-X is the locator located closest to pendant 110, as described in detail below.

Gateway 130 may include a communication device configured to communicate with various devices in environment 100 via wired or wireless connections. For example, gateway 130 may communicate with locators 120 via wireless or wired connections. Gateway 130 may also be coupled to network 140 via a wired connection or wireless connection (e.g., a cellular connection) to allow information regarding pendant 110 to be stored in a location that is remote with respect to other devices in environment 100, such as pendant 110 and locators 120.

Network 140 may include one or more wired, wireless and/or optical networks that are capable of receiving and transmitting data, voice and/or video signals. For example, network 140 may include one or more public switched telephone networks (PSTNs) or other type of switched network. Network 140 may further include one or more satellite networks, one or more packet switched networks, such as an Internet protocol (IP) based network, a software defined network (SDN), a local area network (LAN), a WiFi network, a wide area network (WAN), a Fourth Generation Long Term Evolution (4G LTE) Advanced network, a Fifth Generation (5G) network, a Sixth Generation (6G) network, an intranet, or another type of network that is capable of transmitting data. In one implementation, network 140 may provide packet-switched services and wireless IP connectivity to various components in environment 100 to transmit location related data and/or other data to other devices/systems.

Location determining system 150 may include one or more computer devices having communication, processing and storage capabilities and may be located in or accessible via network 140. Location determining system 150 may receive location data from locators 120 to identify the location of pendants 110 in real time or near real time. This location information may include, for example, a room number, hall number and/or floor number, etc., and enables a party monitoring pendants 110 to track the locations of wearers of pendants 110 in real time or near real time. Location determining system 150 may also store location related data from pendants 110 for access by other devices/systems in environment 100. In other implementations, location determining system 150 may receive information from a locator 120 that includes a label or other ID associated with the locator 120, along with a pendant ID. In this implementation, location determining system 150 may associate the label/ID transmitted by locator 120 with information identifying the room, hall number, floor number, etc. For example, the location information may allow personnel at location determining system 150 and/or an emergency call system (not shown) to dispatch the appropriate personnel to a correct location when the wearer of pendant 110 needs assistance, such as after a fall.

The exemplary configuration illustrated in FIG. 1 is provided for simplicity. It should be understood that a typical environment 100 may include more or fewer devices than illustrated in FIG. 1. For example, environment 100 may include a large number (e.g., hundreds or more) of pendants 110, locators 120, as well as multiple networks 140 and/or multiple location determining systems 150 distributed in environment 100. The multiple elements may provide redundancy in situations in which a portion of network 140 may be unavailable. Environment 100 may also include signal/message repeater devices, network coordinator devices, one or more emergency call systems and other devices used to facilitate monitoring wearers of pendants 110. Environment 100 may also include other network elements or devices, such as routers, switches, monitoring devices, network elements/functions, etc. (not shown), that aid in routing and transporting data in environment 100.

Various functions are described below as being performed by particular components in environment 100. In other implementations, various functions described as being performed by one device may be performed by another device or multiple other devices, and/or various functions described as being performed by multiple devices may be combined and performed by a single device. For example, in some implementations, the functions of repeater and network coordinator 140 may be combined in a single device.

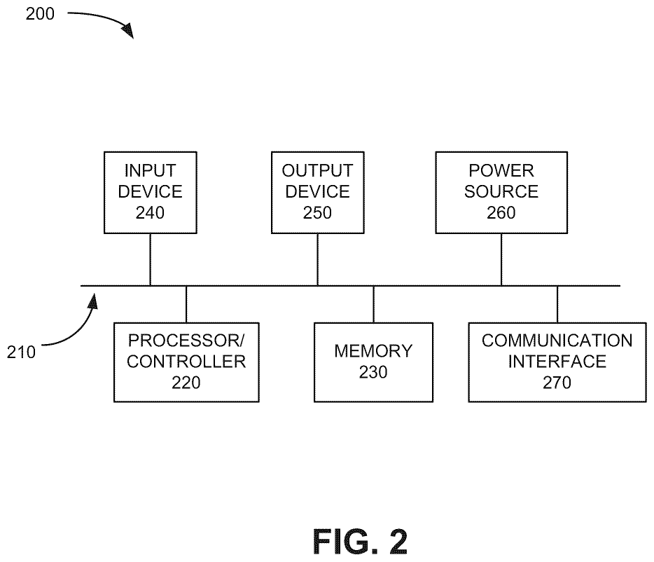

FIG. 2 illustrates an exemplary configuration of a device 200. One or more devices 200 may correspond to or be included in pendant 110, locator 120, location determining system 150 and/or other devices included in environment 100. Referring to FIG. 2, device 200 may include bus 210, processor/controller 220, memory 230, input device 240, output device 250, power source 260 and communication interface 270. The exemplary configuration illustrated in FIG. 2 is provided for simplicity. It should be understood that device 200 may include more or fewer components than illustrated in FIG. 2.

Bus 210 may include a path that permits communication among the elements of device 200. Processor/controller 220 (also referred to herein as processor 220, controller 220 and/or processing logic 220) may include one or more processors, microprocessors, or processing logic that may interpret and execute instructions. Memory 230 may include a random access memory (RAM) or another type of dynamic storage device that may store information and instructions for execution by processor 220. Memory 230 may also include a read only memory (ROM) device or another type of static storage device that stores static information and instructions for use by processor 220. Memory 230 may further include a solid state drive (SSD). Memory 230 may also include a magnetic and/or optical recording medium (e.g., a hard disk) and its corresponding drive.

Input device 240 may include a mechanism that permits a user to input information, such as an input button, a keypad, a keyboard, a mouse, a pen, a microphone, a touch screen, voice recognition and/or biometric mechanisms, etc. Output device 250 may include a mechanism that outputs information to the user, including a display (e.g., a liquid crystal display (LCD)), a speaker, etc. In some implementations, device 200 may include a touch screen display may act as both an input device 240 and an output device 250. Power source 260 may include a battery or other electrical power source for supplying power to device 200.

Communication interface 270 may include one or more transmitters, receivers and/or transceivers that device 200 uses to communicate with other devices via wired, wireless or optical mechanisms. For example, communication interface 270 may include one or more radio frequency (RF) transmitters, receivers and/or transceivers and one or more antennas for transmitting and receiving RF data. For example, when implemented in locator 120, communication interface 270 may include one or more RF transmitters, receivers and/or transceivers and one or more antennas for transmitting and receiving data via a relatively short range RF link and one or more antennas for transmitting and receiving RF data via a longer range connection (e.g., a cellular connection with network 140). Communication interface 270 may also include a modem or an Ethernet interface to a LAN, or other mechanisms for communicating with elements in a network, such as network 140.

Communication interface 270 may operate in accordance with one or more communication standards and may include various processing logic and/or circuitry (e.g., multiplexing/de-multiplexing, filtering, amplifying, converting, error correction, etc.)

In an exemplary implementation, device 200 performs operations in response to processor 220 executing sequences of instructions contained in a computer-readable medium, such as memory 230. A computer-readable medium may be defined as a physical or logical memory device. The software instructions may be read into memory 230 from another computer-readable medium (e.g., a hard disk drive (HDD), SSD, etc.), or from another device via communication interface 270. Alternatively, hard-wired circuitry may be used in place of or in combination with software instructions to implement processes consistent with the implementations described herein. Thus, implementations described herein are not limited to any specific combination of hardware circuitry and software.

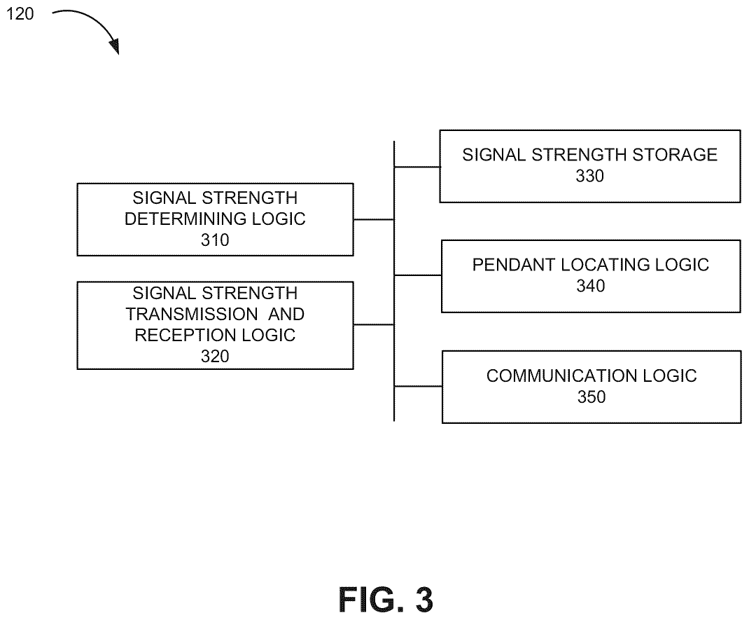

FIG. 3 is a block diagram illustrating exemplary components implemented in locator 120. In an exemplary implementation, some of the components illustrated in FIG. 3 may be implemented by processor 220 executing instructions stored in memory 230.

Referring to FIG. 3, locator 120 includes signal strength determining logic 310, signal strength transmission and reception logic 320, signal strength storage 330, pendant locating logic 340 and communication logic 350. Signal strength determining logic 310 may include logic configured to receive beacon signals transmitted by pendant 110 and determine the corresponding signal strength of the received signals. For example, signal strength determining logic 310 may receive a beacon signal transmitted by pendant 110 and determine a received signal strength indicator (RSSI) value in decibel milliwatts (dBm) corresponding to the signal strength of the beacon signal received by locator 120. This signal strength information may be stored and forwarded to other locators 120, as described in detail below.

Signal strength transmission and reception logic 320 may include logic to transmit, for example, RSSI information generated by signal strength determining logic 310, along with an identifier (ID) of the transmitting locator 120 and an ID of pendant 110. In an exemplary implementation, signal strength transmission and reception logic 320 may transmit the measured RSSI information a predetermined period of time after the beacon signal is received or after the RSSI information is determined. For example, signal strength transmission and reception logic 320 may transmit the RSSI information a regular time interval, a pseudo-random time interval or a random time interval after the beacon signal is received, along with the ID of locator 120 and the ID of pendant 110. Signal strength transmission and reception logic 320 may transmit the message including the RSSI information using, for example, BLE protocol similar to the BLE protocol used by pendant 110. Using BLE protocol may also avoid locators 120 having to exchange messages to pair with each other in order to exchange information. That is, any locator 120 in wireless range of another locator 120 may receive the message with the RSSI information. Further, using BLE protocol may avoid interference with other devices that may be using a different frequency band/protocol with respect to communications in environment 100. Signal strength transmission and reception logic 320 may also include logic to receive RSSI information transmitted by the other locators 120 at regular or different time intervals (e.g., pseudo-random or random time intervals), along with the IDs of the other locators 120 and the ID of pendant 110.

Signal strength storage 330 may include a memory to store signal strength information generated by signal strength determining logic 310, as well as signal strength information associated with other locators 120 received by signal strength transmission and reception logic 320. For example, signal strength storage 330 may store RSSI information received by locator 120 from other locators 120 that received the beacon signal from pendant 110. This information may be used to identify the locator 120 located closest to pendant 110 at the particular time.

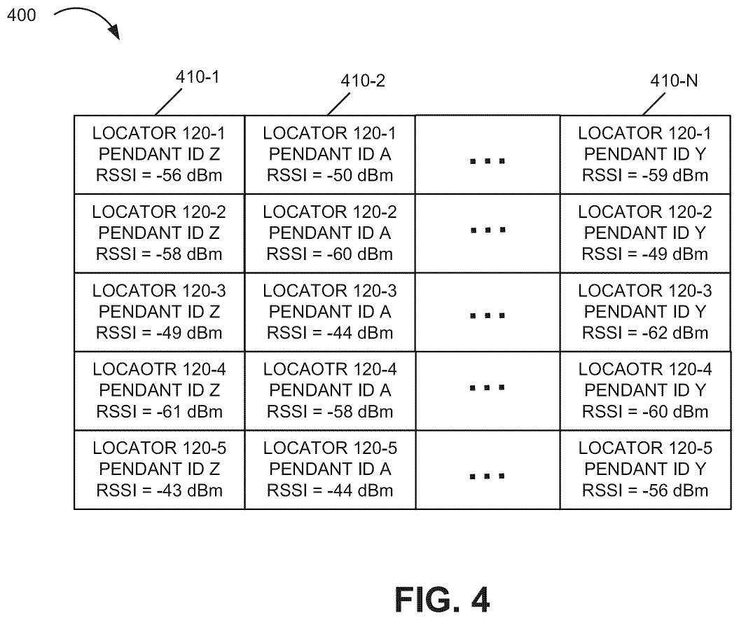

For example, FIG. 4 illustrates an exemplary table 400 stored in signal strength storage 330. Referring to FIG. 4, table 400 includes columns 410-1 through 410-N, with each column storing signal strength information regarding a particular pendant 110. It should be understood that table 400 may include additional columns and/or rows based on, for example, the number of pendants 110 and/or which locators 120 “heard” or received the beacon from pendant 110 in environment 100. For example, each entry in column 410 corresponds to a locator 120 that received a beacon signal from a pendant 110 and communicated that information to locator 120-1.

As described above, each column 410 in table 400 corresponds to RSSI data associated with a particular pendant 110. For example, column 410-1 is associated with a pendant with a pendant ID of Z (referred to as pendant 110-Z) and represents information stored by signal strength determining logic 310 and signal strength transmission and reception logic 320. For example, the first row entry in column 410-1, as well as the first row entry in columns 410-2 through 410-N represents information generated by signal strength determining logic 310 of locator 120-1. Column 410-1 indicates that locator 120-1 measured the RSSI of the beacon signal transmitted by pendant 110-Z and received by locator 120-1 to be −56 dBm. Column 410-1 also indicates that locators 120-2 through 120-5 received the beacon signal and measured the signal strength of the beacon signal transmitted by pendant 110-Z to be −58 dBm, −49 dBm, −61 dBm and −43 dBm, respectively. Table 400 may similarly store RSSI information associated with other pendants 110 in other columns 410 of table 400. For example, column 410-2 stores RSSI values associated with a pendant 110 with a pendant ID of A and column 410-N stores RSSI values associated with a pendant 110 with a pendant ID of Y.

Referring back to FIG. 3, pendant locating logic 340 may include logic to determine which locator 120 in environment 100 is located closest to pendant 110 at a particular time. For example, pendant locating logic 340 may compare signal strength information stored in each column in signal strength storage 330 to identify the locator 120 located closest to pendant 110 based on the RSSI values. For example, in table 400 at column 410-1, pendant locating logic 340 may determine that locator 120-5 has an RSSI value of −43 dBm, which corresponds to the greatest RSSI value for pendant 110-Z. Pendant locating logic 340 for locator 120-1 may then determine that locator 120-1 did not receive the beacon signal with the greatest signal strength for pendant 110, indicating that locator 120-1 is not the locator 120 located closest to pendant 110-Z. That is, locator 120-5 received the beacon signal with the greatest strength and pendant locating logic 340 may determine that locator 120-5 is located closest to pendant 110 at the current time. In this case, pendant locating logic 340 may determine that locator 120-1 will not transmit location information regarding the location of pendant 110-Z since locator 120-1 is not located closest to pendant 110-Z. In this example, locator 120-5 will transit its location information. For example, locator 120-5 will include a table similar to table 400 in which the first entry in each column is associated with the RSSI data generated by the signal strength determining logic of locator 120-5. However, in situations in which locator 120-1, for example, is the locator 120 located closest to a pendant 110, pendant location logic 340 for locator 120-1 will transmit its location to, for example, location determining system 150, as described in detail below. In this manner, pendant locating logic 340 acts to arbitrate among locators 120 to identify the locator 120 with the highest signal strength.

Communication logic 350 may include logic for communicating with devices in environment 100. For example, communication logic 350 may transmit data to and receive data from other locators 120, location determining system 150 and/or other devices in environment 100 via wired, wireless or optical mechanisms.

Although FIG. 3 shows exemplary components of locator 120, in other implementations, locator 120 may include fewer components, different components, differently arranged components, or additional components than depicted in FIG. 3. In addition, functions described as being performed by one of the components in FIG. 3 may alternatively be performed by another one or more of the components of locator 120.

As described above, locator 120 may identify signal strength values of beacons transmitted by pendants 110. Locator 120 may also transmit the identified signal strength values to other locators 120. The locator 120 located closest to one of pendants 110 may then transmit its location information to a central monitoring facility, as described in detail below.

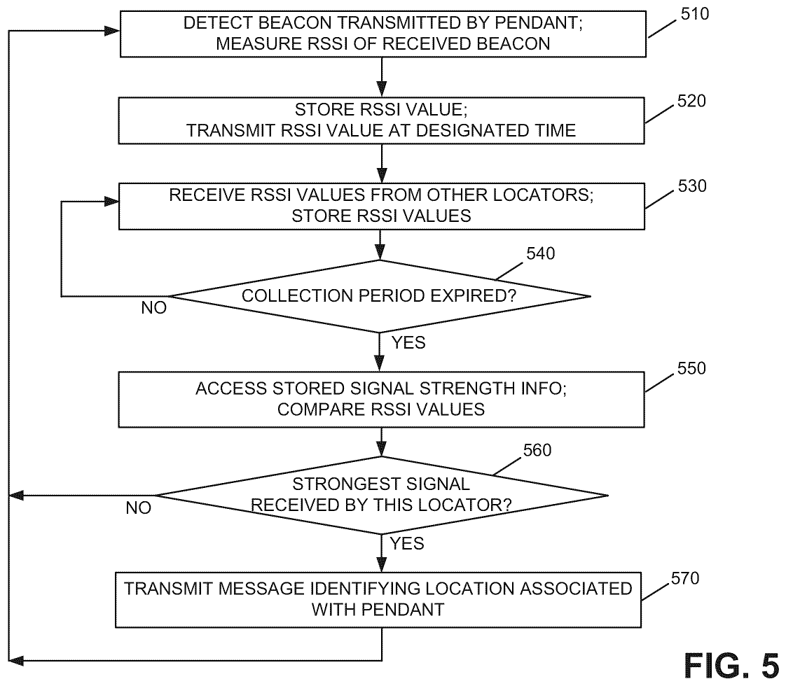

FIG. 5 is a flow diagram illustrating processing associated with environment 100 in accordance with an exemplary implementation. Processing may begin with pendant 110 transmitting a beacon signal at predetermined intervals, and locator 120 detecting the beacon (block 510). In this example, assume that the pendant 110 has a pendant ID of Z (i.e., pendant 110-Z). Further assume that pendant 110-Z transmits a BLE beacon signal at predetermined intervals and that locator 120-1 receives the beacon signal from pendant 110-Z. Signal strength determining logic 310 may determine the signal strength of the received beacon signal, such as measure the RSSI in dBm (block 510).

Locator 120-1 may store the RSSI value in table 400 (block 520). Locator 120-1 may also initiate a timer, such as a pseudo-random or random timer, upon receiving the beacon signal from pendant 110. By using a pseudo-random or random timer, each locator 120 may transmit RSSI information to other locators 120 at different times, thereby avoiding overloading a local network medium and/or avoiding data collisions for signals transmitted by multiple locators 120 at the same time. Locator 120-1 may also initiate a second timer associated with a collection period for receiving data from other locators. In an exemplary implementation, pendant locating logic 340 may store a predetermined data collection time period after a beacon signal is received. That time period may be a relatively short period (e.g., five seconds or less, 15 seconds, 30 seconds, or some period greater than 30 seconds) for receiving RSSI values from other locators 120 so that the location of pendants 110 may be tracked in near real time.

Locator 120-1 may then transmit the determined RSSI value to other locators 120 at the designated time identified by the pseudo-random or random timer (block 520). For example, signal strength transmission and reception logic 320 may transmit the RSSI value measured by locator 120-1, along with an ID of locator 120-1 and an ID of pendant 110-Z. This signal may be received by other locators 120 located within wireless signal range of locator 120-1.

Locator 120 may also receive RSSI values from other locators 120 (block 530). For example, signal strength transmission and reception logic 320 may receive messages transmitted by locators 120-2 through 120-5 that include information identifying the RSSI values measured by each respective locator 120, along with an ID of that locator 120 and an ID for pendant 110-Z. For example, as discussed above with respect to FIG. 4, each other locator 120 that received the beacon signal from pendant 110-Z, may measure the signal strength (e.g., the RSSI) and transmit that signal strength value along with IDs of the particular locator 120 and pendant 110-Z to other locators 120 within wireless range of that locator 120. The messages transmitted by each locator 120 to other locators 120 may be transmitted by, for example, BLE protocol. Signal strength transmission and reception logic 320 may store the received RSSI values for pendant 110-Z in table 400, such as store the values in column 410-1, as illustrated in FIG. 4 (block 530).

Locator 120 may then determine whether the data collection period has expired (block 540). If pendant locating logic 340 determines that the collection period has not expired (block 540—no), processing may return to block 530 to receive additional RSSI values from other locators 120. If, however, pendant locating logic 340 determines that the collection period has expired (block 540—yes), pendant locating logic 340 may access table 400 and compare RSSI values to determine whether locator 120-1 is the locator 120 that received the greatest signal strength value associated with the beacon transmitted by pendant 110-Z (block 550).

For example, referring to FIG. 4, pendant locating logic 340 may access column 410-1 and compare the value in column 410-1 associated with locator 120-1 to determine whether locator 120-1 received the beacon signal with the greatest signal strength (block 560). In this example, pendant locating logic 340 may determine that locator 120-5 has the largest RSSI value for the beacon signal from pendant 110-Z. Continuing with this example, pendant locating logic 340 determines that locator 120-1 did not receive the strongest beacon signal (block 560—no). In this case, processing may return to block 510 for detecting the next beacon signal.

If, however, pendant locating logic 340 determines that locator 120-1 received the strongest beacon signal from pendant 110-Z (block 560—yes), pendant locating logic 340 may transmit a message to, for example, location determining system 150, identifying the location of locator 120-1 (e.g., a room number, a hallway/corridor number, a floor number, and/or geographical coordinates, etc.), along with an ID of pendant 110-Z (block 570). In other implementations, pendant locating logic 340 may transmit a message including an ID for locator 120-1 along with an ID of pendant 110-Z. In such an implementation, location determining system 150 may store information identifying the physical locations of each locator 120. In each case, location determining system 150 may then determine the location or approximate location of pendant 110-Z at that particular time based on signals from one of locators 120. Processing may return to block 510 for processing the next beacon signal.

In situations in which two more locators 120 have the same, highest RSSI value associated with a beacon signal from a particular pendant 110, both of the locators 120 may transmit the location information to location determining system 150. For example, in table 400 at column 410-2, locators 120-3 and 120-5 have the highest RSSI value of −44 dBM for pendant 120 with a pendant ID of A (i.e., pendant 110-A). In this case, location determining system 150 may receive the location information from both locators 120-3 and 120-5 and search the location history for pendant 110-A to identify the most recent location(s) of pendant 110-A (e.g., the recent locations determined over the last minute, two minutes, etc.). Location determining system 150 may then determine the location for pendant 110-A as the location associated with one of the locators 120-3 or 120-5 matching the most recent location(s). Alternatively, location determining system 150 may determine that pendant 110-A is located between locators 120-3 and 120-5 and generate an approximate location for pendant 110-A.

In some instances, due to the physics of RF signal propagation, a pendant 110's beacon may be received by a particular locator 120 that is a significant distance away from the actual location of pendant 110, but that locator 120 is determined as being the closest locator 120 to pendant 110 based on the RSSI information. In these instances, location determining system 150 may use various techniques, such as Kalman filtering, to filter out these anomalous location determinations.

In an exemplary implementation, after pendant locating logic 340 has determined whether to transmit a message to location determining system 150 for a particular pendant 110, pendant locating logic 340 may clear column 410-1 in table 400 for that particular pendant 110 and wait to receive and measure the next beacon signal transmitted by that particular pendant, as well as receive RSSI information associated with that pendant 110 from other locators 120. For example, after locator 120-1 has determined whether to transmit a message for pendant 110 with ID Z, locator 120-1 may clear the entries in column 410-1 of table 400.

In addition, locator 120-1 may process all received beacon signals in a similar manner. For example, as described above with respect to table 400, column 410-2 may store beacon information associated with pendant 110 with an ID of A and column 410-N may store beacon information associated with pendant 100 having an ID of Y. Pendant locating logic 340 may similarly identify if locator 120-1 received the strongest beacon signal for pendants 110 with IDs of A or Y, and if so, transmit a message to location determining system 110 identifying locator 120-1 and the particular pendant 110.

As described above, by determining which locator 120 is located closest to a pendant 110 and only having that locator 120 transmit location related information to, for example, location determining system 150, the data traffic in environment 100 associated with transmitting pendant location information may be reduced (e.g., reduced by a factor of N:1, where N represents the number of locators 120). In some implementations, data traffic may be further reduced by comparing signal strength values transmitted by the same pendant 110 for consecutive periods of time. For example, assume that locator 120-1 is located closest to a pendant 110. In this example, further assume that the subsequent beacon signals from pendant 110 is received by locator 120-1 and locator 120-1 is still the closest locator 120 to pendant 110, but that the RSSI value is the same or approximately the same as the measured RSSI for the previously received beacon signal. For example, assume that the measured RSSI value is within a predetermined dBm value (e.g., within plus/minus one to three dBm) of the previous measured RSSI value. In this case, pendant locating logic 340 may determine that pendant 110 has not moved or moved just a small distance (e.g., less than a predetermined distance), from the time of the previous beacon signal. In such an implementation, pendant detection logic 340 may forego the transmission of a message with the location information to location determining system 150 associated with the second received beacon signal. In this manner, additional data traffic may be eliminated or reduced in environment 100. However, to ensure that the location data does not become too stale/old in situations where pendant 110 is not moving, pendant detection logic 340 may only forego transmissions for a predetermined period of time (e.g., 30-60 seconds) before a location update message is sent.

Implementations described herein reduce data traffic associated with transmitting location information to a central monitoring device, such as transmitting information from location monitoring devices associated with tracking wearers of pendants 110. By reducing the network traffic, data collisions may be reduced and potential overload of the network medium may also be reduced. This may also allow other systems that share the same network medium to avoid issues with respect to transmitting data.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, features have been described above with respect to transmitting RSSI information from one locator 120 to other locators 120. In some implementations, each locator 120 may transmit the RSSI information multiple times to ensure that at least one of the transmissions is received by one or more other locators 120. Further, in some implementations, each locator 120 may transmit the RSSI information multiple times via different channels using different frequencies. Using different channels/frequencies for the transmissions may make it more likely that at least one of the data transmissions will be received by another locator 120.

Further, features have been described above mainly with respect to locators 120 transmitting and receiving information wirelessly. In other implementations, locators 120 may communicate a wired backhaul medium. In such implementations, data transmissions in environment 100 with respect to transmitting location related information may still be reduced by a factor of N:1, where N is the number of locators.

Still further, features described herein may be implemented in an environment which uses a same network medium for transmitting beacon signals and transmitting location information between locators 120. In other implementation, locators 120 may use a different network medium to transmit RSSI information to other locators 120 than the network medium used for the beaconing and backhaul in environment 100.

In addition, features have been described above with respect to tracking pendant location in a real time location system that employs BLE beacons. It should be understood that implementations described herein may also be used in other real time locations systems or non-real time locations systems that employ BLE beacons or other wireless or wired communication protocols and that may use a separate network backhaul medium for transmitting and receiving other data.

Further, while series of acts have been described with respect to FIG. 5, the order of the acts may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A device, comprising:
a communication interface; and
processing logic configured to:
receive, from a wearable device, a signal,
determine a signal strength of the received signal,
receive, via the communication interface, messages from a plurality of other devices that received the signal, wherein each message includes a signal strength value corresponding to a signal strength measured by one of the plurality of other devices,
determine whether the device received the signal with a greatest signal strength, and
transmit, via the communication interface and in response to determining that the device received the signal with the greatest signal strength, a message to a monitoring device indicating an identifier (ID) of the wearable device and at least one of a location of the device or an ID associated with the device.

2. The device of claim 1, wherein the processing logic is further configured to:
determine that the device did not receive the signal with the greatest signal strength, and
not transmit the message to the monitoring device, in response to determining that the device did not receive the signal with the greatest signal strength.

3. The device of claim 1, wherein the processing logic is further configured to:
transmit, to the plurality of other devices and via the communication interface, a second message including information identifying the signal strength of the received signal.

4. The device of claim 3, wherein the processing logic is configured to transmit the second message at a random or pseudo-random time after receiving the signal.

5. The device of claim 1, further comprising:
a memory configured to store a plurality of signal strength values, wherein each of the plurality of signal strength values is associated with one of the plurality of other devices.

6. The device of claim 5, wherein the processing logic is further configured to:
access the memory, and
compare the determined signal strength of the received signal to the plurality of stored signal strength values to determine whether the device received the signal with the greatest signal strength.

7. The device of claim 1, wherein the message comprises:
the ID of the wearable device and the ID associated with the device.

8. The device of claim 1, further comprising:
a memory configured to store signal strength values associated with signals associated with a plurality of wearable devices,
wherein the processing logic is configured to:
access the memory to determine whether the device is located closer to one of the plurality of wearable devices than any of the other devices, and
transmit a second message identifying the location of the device in response to determining that the device is located closer to the one of the plurality of wearable devices than any of the other devices.

9. The device of claim 8, wherein the processing logic is further configured to:
receive a second signal from the wearable device,
determine a signal strength of the received second signal,
determine, based on the signal strengths of the first and second signals, whether the wearable device has moved, and
not transmit the message to the monitoring device in response to determining that the wearable device has not moved or moved less than a predetermined distance.

10. The device of claim 1, wherein the wearable devices comprises a pendant configured to be worn around the neck or a wrist of a user.

11. A system, comprising:
a plurality of devices, wherein each of the devices comprises:
a communication interface, and
processing logic configured to:
receive, from a wearable device, a signal,
determine a signal strength of the received signal,
receive, via the communication interface, messages from other ones of the plurality of devices that received the signal, wherein each message includes a signal strength value corresponding to a signal strength measured by one of the other ones of the plurality of devices,
determine whether the device received the signal with a greatest signal strength, and
transmit, via the communication interface and in response to determining that the device received the signal with the greatest signal strength, a message to a monitoring device indicating an identifier (ID) of the wearable device and at least one of a location of the device or an ID associated with the device.

12. The system of claim 11, wherein the processing logic is further configured to:
determine that the device did not receive the signal with the greatest signal strength, and
not transmit the message to the monitoring device, in response to determining that the device did not receive the signal with the greatest signal strength.

13. The system of claim 11, wherein the processing logic is further configured to:
transmit, to the other ones of the plurality of devices and via the communication interface, a second message including information identifying the signal strength of the received signal.

14. The system of claim 13, wherein the processing logic is configured to transmit the second message at a random or pseudo-random time after receiving the signal.

15. The system of claim 11, wherein each of the plurality of devices further comprises:
a memory configured to store a plurality of signal strength values associated with the received signal.

16. The system of claim 15, wherein the processing logic is further configured to:
access the memory, and
compare the determined signal strength value of the received signal to the plurality of stored signal strength values to identify whether the device received the signal with the greatest signal strength.

17. The system of claim 11, wherein the wearable device comprises a pendant configured to be worn by a user, and wherein the system further comprises:
a plurality of pendants.

18. The system of claim 17, further comprising:
a location monitoring system, wherein the location monitoring system is configured to:
receive messages from the plurality of pendants, and
track locations of the pendants based on the received messages.

19. A non-transitory computer-readable medium having stored thereon sequences of instructions which, when executed by at least one processor of a device, cause the at least one processor to:
receive, from a wearable device, a signal;
determine a signal strength of the received signal;
receive, via a communication interface, messages from a plurality of other devices that received the signal, wherein each message includes a signal strength value corresponding to a signal strength measured by one of the plurality of other devices;
determine whether the device received the signal with a greatest signal strength; and
transmit, via the communication interface and in response to determining that the device received the signal with the greatest signal strength, a message to a monitoring device indicating an identifier (ID) of the wearable device and at least one of a location of the device or an ID associated with the device.

20. The non-transitory computer-readable medium of claim 19, wherein the instructions include instructions to further cause the at least one processor to:
determine that the device did not receive the signal with the greatest signal strength, and
not transmit the message to the monitoring device, in response to determining that the device did not receive the signal with the greatest signal strength.
